(19) United States
(12) Patent Application Publication
(10) Pub. No.: US 2016/0121299 A1
(43) Pub. Date: May 5, 2016

(54) REDUCED GRAPHENE OXIDE COMPOSITE MATERIAL

(71) Applicant: National Taiwan University, Taipei (TW)

(72) Inventors: Huan-Tsung Chang, Taipei (TW); Arun Prakash Periasamy, New Taipei City (TW); Wen-Ping Wu, Changhua County (TW); Guan-Lin Lin, New Taipei City (TW)

(21) Appl. No.: 14/925,997

(22) Filed: Oct. 29, 2015

Related U.S. Application Data
(60) Provisional application No. 62/069,833, filed on Oct. 29, 2014.

(30) Foreign Application Priority Data
Sep. 11, 2015 (TW) 104130087

(51) Int. Cl. B01J 20/26; B01J 20/30

(52) U.S. Cl. CPC B01J 20/262; B01J 20/3085; B01J 20/3078

(57) ABSTRACT

The preparation of functionalized reduced graphene oxide (RGO) composite materials on various fibrous substrates has been proposed. The functionalized RGO composite fibrous materials absorb various types of oils efficiently within 20 seconds, with great absorption capacity. The maximum absorption capacity values for bicycle chain oil and used motorcycle engine oil are 880.8% and 839.1%, respectively. Simply squeezing the functionalized RGO composite materials allows the removal of the absorbed oil for reuse. The functionalized RGO composite fibrous materials have been used to efficiently separate oil/water mixture through a flowing system. Having the advantages of faster absorption rate, reusability, and low-costs, the functionalized RGO composite fibrous materials holds great potential as a superabsorbent for efficient removal and recovery of oil spills, and for separation of water/oil mixtures.

### CROSS-REFERENCE TO RELATED APPLICATION

This application claims the priority benefit of U.S. provisional application Ser. No. 62/069,833, filed on Oct. 29, 2014 and Taiwan application serial no. 104130087, filed on Sep. 11, 2015. The entirety of each of the above-mentioned patent applications is hereby incorporated by reference herein and made a part of this specification.

### BACKGROUND OF THE INVENTION

1. Field of the Invention

The present invention relates to a composite material, which particularly relates to a reduced graphene oxide (RGO) composite material.

2. Description of Related Art

Inevitable oil spill events often trigger serious environmental contamination problems that have become holocaust to the local ecosystems. The removal of oil spills is an important issue which needs to be addressed to ensure the environmental protection and ecological concerns. Also, additional economic values may be created if the processed oil is recycled. Even though various commercial absorbents, such as modified organophilic clays, fibrous materials and polyurethane, are available for removing oil spills, certain concerns, including tedious preparation processes, poor absorption capacity, poor recyclability and durability and high costs for the production and handling of the used polymers, still exist. Natural or synthetic fibrous materials (such as sponges or fabrics) have been used to clean up the oil spills, but, they have low oil absorption capacity, poor durability and the absorbed oil is unrecyclable. Commercially available oil absorbent sheets or blankets have been used to remove oil, but the high costs, poor oil removal capability and air pollution as a result of the subsequent burning process limit their wide applications thereof.

### SUMMARY OF THE INVENTION

The present invention provides a reduced graphene oxide (RGO) composite materials for oil removal and recovery and preparation methods thereof. The separation of oil/water mixture using the RGO composite materials through a flow system has also been proposed. By using natural and synthetic fibrous materials as the substrate, one or more oil superabsorbent composite materials were prepared and used for oil removal and oil recovery. The preparation method disclosed herein includes the development of a simple hydrothermal approach for the preparation of RGO composite, which has advantages of safe operational processes, quick and straightforward synthetic procedures, and use of cheap raw materials. The obtained RGO composite has exceptional properties, such as fast oil absorption rate, excellent hydrophobicity, lightweight, high chemical stability and reusability, and is suitable to be used as an absorbent material for large-scale cleaning of oil spills in the sea and/or the land, or applicable in daily life as a cleaning material for removing the oil.

The present invention provides a RGO composite material, comprised of a substrate and a RGO sheet coated on and/or into the substrate.

The RGO sheet is functionalized with a polymer and coated with a silane compound or a porphyrin compound. The substrate is comprised of fibrous materials or porous materials. The RGO composite material is prepared according to the preparation method as follows. The substrate is soaked in an aqueous solution of the polymer/graphene oxide (GO) solution, and the crosslinking agent or the chelating agent is added. The pH of the solution is adjusted to be weakly acidic, and the reducing agent is then added to reduce GO adsorbed onto the substrate into RGO through the hydrothermal approach so as to obtain the polymer/RGO modified substrate. The polymer/RGO modified substrate is soaked in an aqueous solution of the silane compound or the porphyrin compound at an ambient temperature to obtain the RGO composite material.

In the embodiments, the silane compound may be phenyltrimethoxysilane (PTMOS) or vinyltrimethoxysilane.

In the embodiments, the silane compound may be PTMOS, and a content of PTMOS in the RGO composite material is 5%-20%, preferably 20%.

In the embodiments, the porphyrin compound may be iron porphyrin.

In the embodiments, the crosslinking agent or the chelating agent may be 1-ethyl-3-(3-dimethylaminopropyl)carbodiimide (EDC), ethylenediaminetetraacetic acid (EDTA) or citric acid.

In the embodiments, the polymer may be polyethylenimine (PEI), polyvinyl alcohol (PVA) or polyethylene oxide (PEO).

In the embodiments, the reducing agent may be hydrazine. Alternatively, other mild or strong organic reducing agents may be used. GO adsorbed on the substrate is reduced into RGO through the hydrothermal approach over an temperature range of 60° C.-120° C. for 1-24 hours.

As described above, RGO composite materials, such as phenyltrimethoxysilane/polyethylenimine/reduced graphene oxide (PTMOS/PEI/RGO) sponge (denoted as PRP sponge hereinafter), of the present invention not only have high oil absorption capacity, but also are of low costs and applicable as the absorbent materials for the removal and recovery of oils. Such composite materials are reusable and eco-friendly. The RGO composite material(s) described in the present invention holds great potential to be used as absorbent materials in large-scale clean-up of oil spills (ex: sea or land). Certainly, the RGO composite material(s) disclosed in the present invention also may be used as a household cleaning products.

### BRIEF DESCRIPTION OF THE DRAWINGS

The drawings are included to provide a further understanding of the invention, and are incorporated in and constitute a part of this specification. The drawings illustrate embodiments of the invention and, together with the description, serve to explain the principles of the invention.

FIGS. 1A-D show the high-resolution SEM images of various sponges prepared according to different embodiments of the present invention.

FIGS. 2A-2B show the high-resolution HAADF-STEM images of the PEI/RGO sponges prepared according to different embodiments under various synthetic conditions of the present invention.

FIGS. 3A-3E show the snapshots of the time dependent absorption of bicycle chain oil from water using a PRP sponge.

FIG. 3F shows the photographs of oil/hexane mixture (left), oil and hexane containing dye separated into two layers by gravity force (middle) and recovered oil (right).

FIG. 4A is a graph illustrating the reusability of the PRP sponge for the removal of bicycle chain oil.

FIG. 4B is a bar chart illustrating the oil absorption capacity versus the recycle number of the control group bare sponge.

FIG. 4C shows the comparison of the oil absorption capacity of the PRP sponge with the bare sponge.

FIG. 5 shows the water and oil separated from the oil/water mixture using the PRP sponge reused at least 3 times.

### DESCRIPTION OF THE EMBODIMENTS

The preparation method disclosed in the present invention uses fibrous materials (such as natural or synthetic fabric/cloths) or porous materials (such as the natural or synthetic sponge) as the substrate to prepare the PTMOS-treated, PEI-functionalized RGO film coated on and/or into the substrate. The material of the porous substrate includes natural or synthetic materials and fibrous materials with large numbers of pores with different pore volumes.

The RGO has not only hydrophobic surfaces and a large surface area but also it has a high mechanical strength, and is suitable to be used for absorbing oil. However, the smooth morphology of the RGO sheets decreases their oil absorption efficiency. Though functional graphene/polypyrrole foams have been used for removing oils, it is difficult to remove the oil from the RGO surface as a result of their strong absorption. Burning these materials absorbed oil has been suggested, but it raises safety and ecological concerns.

PEI is a polymer containing many amino groups and is soluble in hot water and chloroform at low pH values. PEI can be used to modify various substrates through simple dynamic coating or covalent bonding. With its polycationic character, PEI has been used to modify the surfaces of cellulose paper to enhance its hydrophobicity. Through the formation of amide bonds between the amino groups of PEI and the carboxylic groups on the RGO surface, PEI has been used to provide positive charges on the surface of RGO. Having amino groups tethered on the backbone of PEI, the positive charged surface of PEI-modified RGO is ready for adsorbing anionic species. Hydrogen bonding and Van der Waals' forces between the surfaces of cellulose fibres and/or sponges and that of PVA or PEO stabilizes the coatings.

The present invention describes the preparation of low-cost and effective oil absorbents for removing oil spills and recycling of the oil. A simple hydrothermal approach is demonstrated for the preparation of PEI functionalized porous RGO sheets on the sponges. The hydrophobic coating was then made using the silane compound(s) and the composite materials were thus prepared. Preferable reaction conditions of the hydrothermal approach include: concentration of hydrazine used (0.8 to 1.2 M), pH of the reaction solution (weakly acidic aqueous solution), the reaction temperature (60° C. to 170° C.), and the reaction time (1 to 24 hours). Under these conditions, the smooth graphene oxide (GO) sheet(s) is processed (cut) by PEI and the functional groups on the GO sheet(s) are removed by PEI, leading to the formation of rough and highly porous PEI functionalized-RGO sheet(s) on and within the pores of the sponge(s). To further improve the oil absorption capacity of the as-prepared PEI/RGO sponge(s) and the subsequent release of the oil from the sponge(s), PTMOS, as a sol-gel precursor to provide the hydrophobic coating, is utilized to treat the sheet(s). The PTMOS provided hydrophobic coating which increased the hydrophobicity and the diffusion rate of the oil through the porous networks of the sponge, thus increasing the oil absorption capacity and oil absorption rate of the composite material(s).

The preparation of PEI/RGO fibrous material(s)

The preparation of the silane/polymer-RGO-coated hydrophobic material

Commercially available fibrous materials (such as natural or synthetic sponges, natural or synthetic fabrics) were separately soaked in acetone and pure water under ultrasonication, and dried in the oven. Clean fibrous materials were soaked in the PEI/GO solution, and the crosslinking agent or chelating agent was added. After adjusting the pH value of the reaction solution (the pH value ranges from 5 to 7), the reducing agent was added and then heated to reduce the GO adsorbed on the surfaces of the fibrous materials into RGO to obtain the PEI/RGO coated fibrous materials.

The preparation of the PRP fibrous material(s)

The silane compounds (such as, PTMOS and vinyltrimethoxysilane) or the porphyrin compound (such as iron porphyrin) was dissolved in a solvent (such as hexane, ethanol and water) to prepare the silane or phorphyrin solution. The pH of the solution was then adjusted to a suitable value (the pH value ranges from 9.0 to 12.0). The as-obtained PEI/RGO fibrous material was soaked in the solution, reacted at the ambient temperature and cured. The PRP coated fibrous material(s) was dried prior to silane coating.

PEI was used in the above preparation method, but other polymers such as PVA and PEO and the carbon-containing material such as GO, multiwalled carbon nanotubes (MWCNTs), single walled carbon nanotubes (SWCNTs), carbon nanoparticles and carbon-dots (C-dots) may be used. The crosslinking agent or the chelating agent, including EDC, EDTA or citric acid may be used. For the above preparation method, the silane compound (e.g. PTMOS, vinyltrimethoxysilane) or the porphyrin compound (e.g. iron porphyrin) may be used in combination with the organic solvent.

The preparation of PEI/RGO fibrous materials (the PEI/GO sponge)

Commercially available sponges were cut into blocks and soaked in the ultrapure water under ultrasonication for cleaning, then dried in the oven. The clean sponge blocks were soaked in aliquots of the PEI/GO solution, and the crosslinking agent or the chelating agent was added. The pH of the solution was adjusted to a suitable pH value. The reducing agent was added and then GO was reduced to RGO through the hydrothermal treatment. The as-prepared sponge was dried in the oven to obtain the PEI/RGO fibrous material.

The preparation of the PEI/GO sponge

Following the above preparation method, the PEI/GO sponge was prepared at the ambient temperature through the reaction for 3 hours but without adding the reducing agent, and used for comparison.

The preparation of the PRP sponge

The obtained PEI/RGO sponges were soaked in the solution of PTMOS and n-hexane (as the initiator) at the ambient temperature for reaction. The pH of the reaction solution was adjusted to a suitable value (the pH value ranges from 9.0 to 12.0) and dried in oven. Thus, the PRP sponges were obtained. Based on the test results for the hydrophobicity, the contact angles were determined to be 65.74, 91.41, 94.78 and 95.82° for the PEI/RGO sponges coated with 5, 10, 15 and 20% PTMOS, respectively. The content of PTMOS in the PRP sponge is preferably 20%.

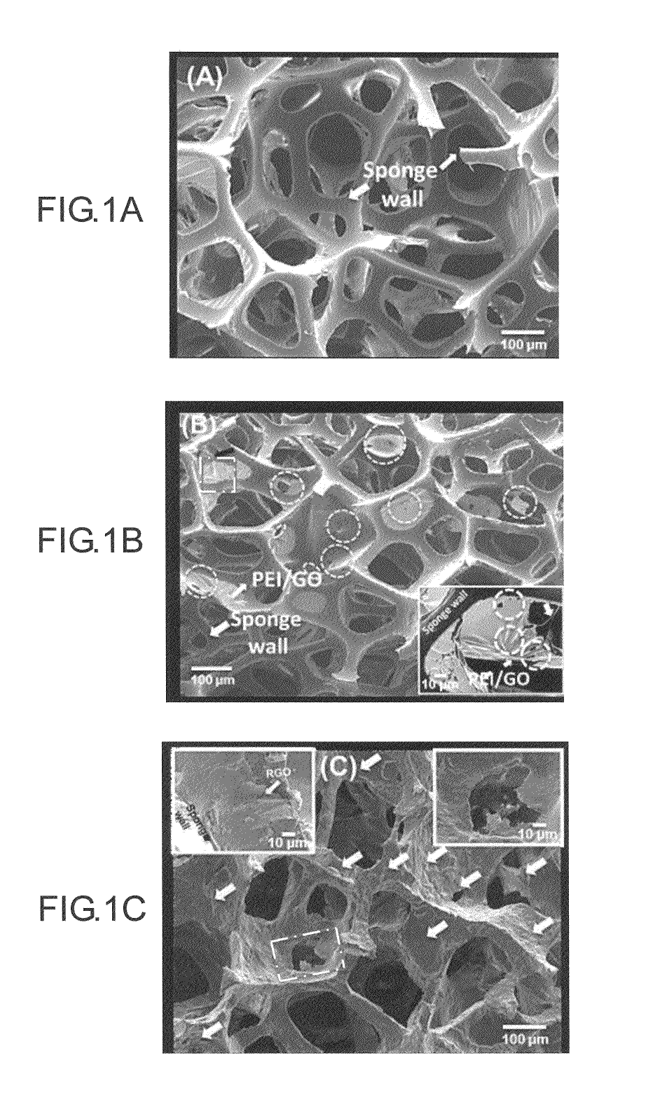

In the embodiments of the present invention, the PRP sponges were considered to be one of the substrates of our interest that we investigated and as an example of the functional fibrous materials. The commercially available bare sponge was used as the control. High-resolution scanning electron microscopy (SEM) images revealed the smooth walls that interconnect to form network-like structures in the commercially available sponge (as shown in FIG. 1A). The morphology of the as-prepared PEI/GO sponge was identified by high-resolution SEM, showing that nanopores with variable pore volumes (indicated by arrows as shown in Fig. B) were formed within the sponge network. Compared with the RGO (left inset of FIG. 1C, denoted as RGO), there are more pores in the PEI/RGO (right inset of FIG. 1C), showing that PEI further cuts/or modifies RGO to form nano pores. In order to increase the hydrophobicity of the sponge surface, PTMOS coating was used. The coating of PTMOS on the wall is apparent in the SEM image as shown in FIG. 1(D). The size (10±2 μm) of the sphere-like aggregates reveals that condensation of PTMOS on the surface of walls in the sponge took place (inset to FIG. 1(D)). The bare sponge, the PEI/GO sponge, the PEI/RGO sponge, and the

PRP sponge were all analyzed by the energy-dispersive X-ray spectroscopy (EDS) and were shown having different carbon, oxygen, nitrogen and silicon elemental compositions.

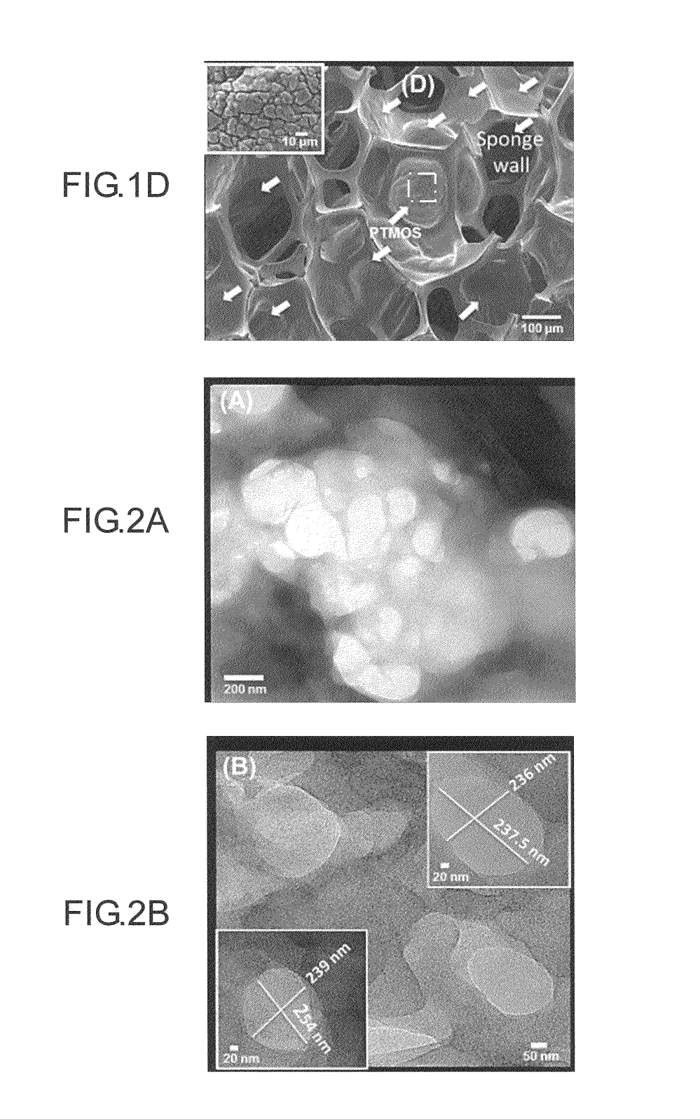

To further investigate the structures of PEI/RGO in the sponges, the PEI/RGO sheets were separated from the as-prepared PEI/RGO sponges through ultrasonication for 10 min. High angle annular dark field scanning transmission electron microscopy (HAADF-STEM) images revealed that many pores were formed on the surface or edges of PEI/RGO sheets; the diameters of the pores along the transverse axis being 236-239 nm and the diameters of the pores along the vertical axis being 230-260 nm (as shown in FIG. 2A-2B). FIG. 2A displays a low-magnification HAADF-STEM image (the scale bar being 200 nm). FIG. 2B displays a high-magnification HAADF-STEM image (the scale bar being 50 nm). The inset in FIG. 2B displays a high-magnification HAADF-STEM image (the scale bar being 20 nm). All these images showing that PEI/RGO sheets have nanopores with different diameters that increase their oil absorption capacity.

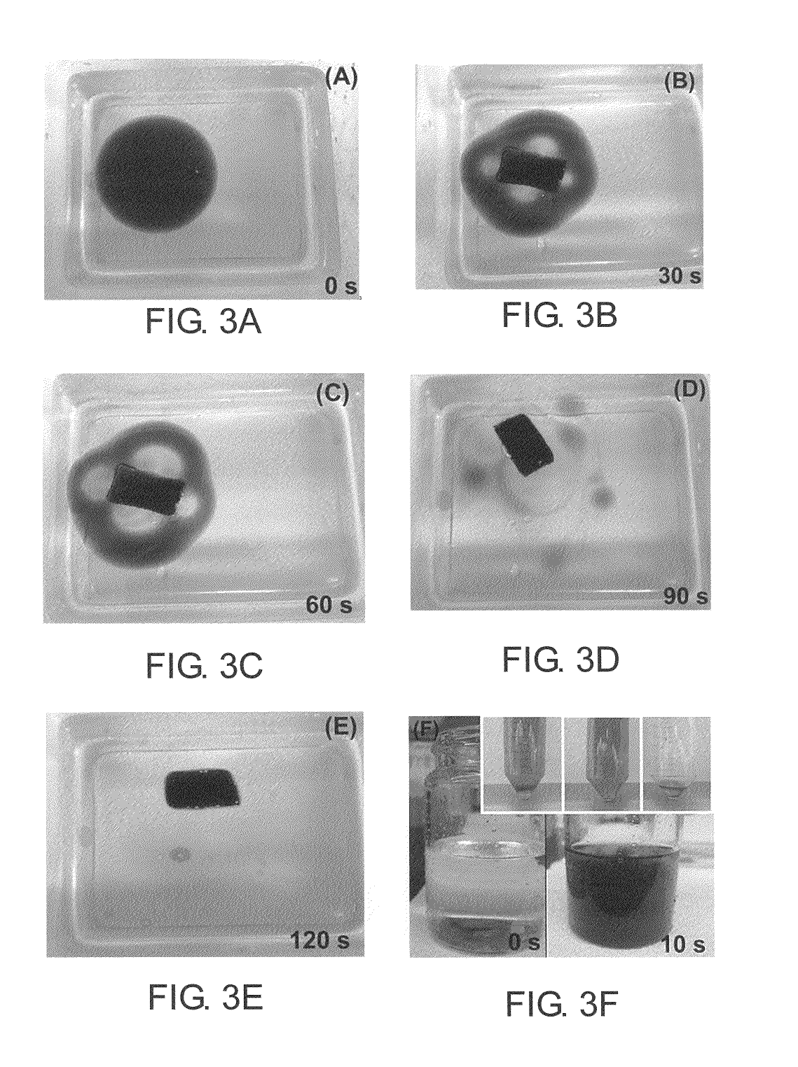

The as-prepared PRP sponge was used to test the absorption capacity of the bicycle chain oil and the motorcycle engine oil. The bicycle chain oil labeled with the Oil red O was dropped on the water surface. The PRP sponge (the black squares in FIG. 3A-3E) was subsequently dropped on it to absorb the oil. As shown in FIG. 3A-3E (0, 30, 60, 90 to 120 seconds), it was observed that PRP sponges gradually absorbed the oil and removed the oil from the water surface within 2 minutes, indicating great oil absorption capability of the PRP sponges. The oil retained within the sponge(s) was removed within 10 seconds by simply squeezing it and the sponge was ready to be reused. Alternatively, the oil-absorbed PRP was soaked in n-hexane, and the oil was released into hexane completely within 10 seconds, changing hexane from colourless to red, showing quick oil recycle ability. The oil/hexane mixture was transferred into a polypropylene tube, in which the oil and hexane layers were formed after 5 min (inset of FIG. 3F), allowing recovery of oil by pipetting out the hexane containing the red dye. FIG. 3F shows the photographs of oil/hexane mixture (left), oil and hexane containing dye separated into two layers by gravity force for 5 min (middle) and the recovered oil (right) after pipetting hexane containing dye. The top hexane layer was removed using a pipette. The used sponge may be dried in the oven at 60° C. for 15 minutes and was recycled for reuse.

The oil absorption capacity of the PRP sponge was determined from the equation: Oil absorption capacity (%)=(Mₜ−Mₒ)/Mₒ×100

Mₒ and Mₜ are the weights of the sponge measured before and after absorbing the oil, respectively.

The oil absorption capacity of the PRP sponges ranges from 688.7% (PTMOS content of 5%), 716.2% (PTMOS content of 10%), 790.9% (PTMOS content of 15%) to a high capacity of 880.8% (PTMOS content of 20%).

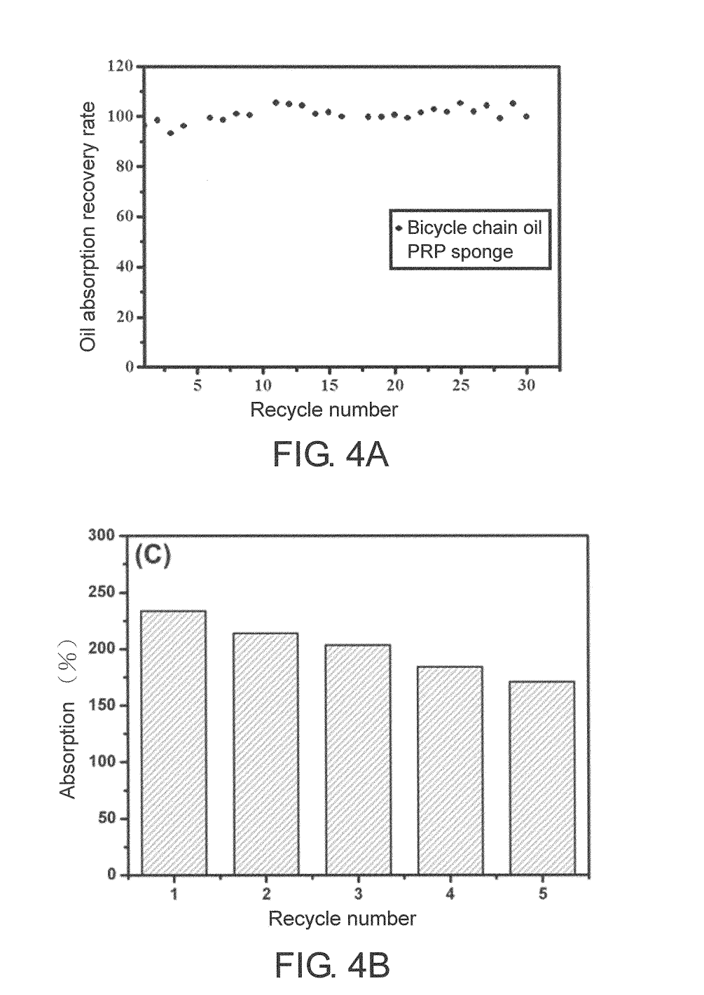

As mentioned above, the oil absorption capacity of the PRP sponges toward the bicycle chain oil can reach 880.8% (up to about 8.8 times of the oil of its own weight). Interestingly, PRP sponges retained 99% of their original oil absorption capacity after repeatedly being used for at least 30 times, proving their good reusability (FIG. 4A).

The maximum oil absorption capacity of the bare sponge is 233.8%, which is only a quarter of the oil absorption capacity of the PRP sponge(s). After 5 times of usage, the bare sponge merely retains 73% of its original oil absorption capacity, showing poor reusability (FIG. 4B).

The PRP sponge(s) prepared as described above can absorb the motorcycle engine oil completely within 20 seconds, which shows similar efficiency as the porous boron nitride nano sheets. The PRP sponge(s) shows great oil absorption capability, holding great potentials to be used as an absorbent material for large-scale cleaning of oil spills in the sea or land. The PRP sponge(s) can absorb the motorcycle engine oil up to a weight more than about 17 times of its own weight. Hence, the RGO composite material(s) as disclosed in the present invention presents the better oil absorption capacity compared to other known commercial composite materials. The PRP sponge shown in FIG. 4C has a PTMOS content of 20% and the maximum oil absorption capacity of the PRP sponge(s) is 7.2 times higher than that of the bare sponge.

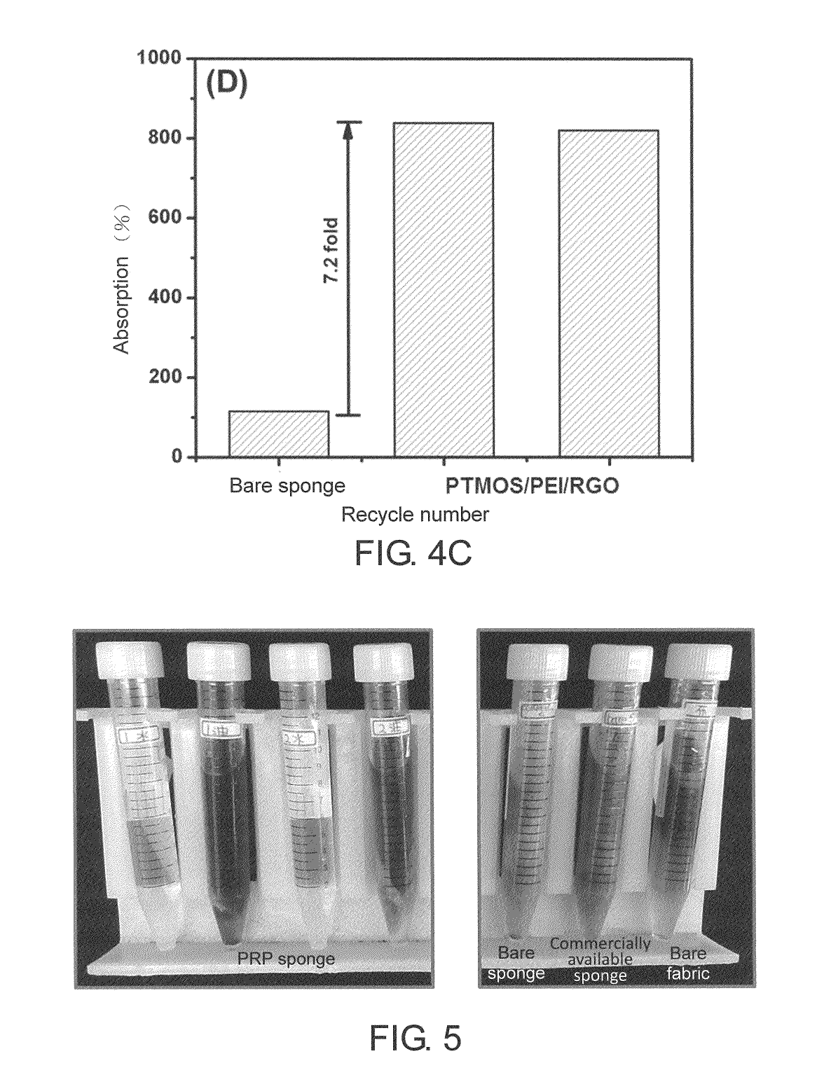

FIG. 5 shows that after more than three times of usage, the PRP sponge still presents satisfactory oil-water separation efficiency (the second and the fourth to the left tubes shows the recycled oil separated from the PRP sponge after repeated usage).

Compared to the bare sponge, commercial sponge or bare fabrics, the PRP sponge shows better oil-water separation efficiency.

The RGO composite materials prepared according to the present invention are hydrophobic and are capable of absorbing various types of cooking oils with different viscosities, such as sunflower oil, olive oil, coconut oil and castor oil, within 20 seconds.

The preparation method disclosed in the present invention is straightforward, highly effective, and less costly. The RGO composite material(s) obtained by the preparation method proposed herein not only possesses great oil absorption capability, potentials in recycling the oil but also is of lower costs and reusable. Thus the RGO composite materials of the present invention hold great potentials to be used as absorbent materials for large-scale cleaning of oil spills. Certainly, the RGO composite materials of the present invention is applicable to be used as household cleaning products or even cleaning products for biological bodies.

The prepared silane polymer-coated hydrophobic composite material as proposed in the present invention has a structure similar to that of the porous leaf of a plant (nanoporous structure). The nanoporous structure enhances the oil absorption capability and the oil desorption capability. With the properties of lightweight, porosity, high elasticity, and hydrophobicity, the RGO-coated fibrous composite materials as disclosed in the embodiments of the present invention have high oil absorption capability toward oils of different viscosities, including the crude oil, gasoline, bicycle chain oil, motorcycle engine oil, and cooking oils. The RGO-coated fibrous composite materials are able to absorb the oil more than 17 times of the weight of the fibrous material (such as the sponge).

The maximum oil absorption capacities of the RGO composite material toward the bicycle chain oil and the motorcycle engine oil are 880.8% and 839.1%, respectively. The composite material can absorb the oil within 20 seconds and the absorbed oil can be released within 10 seconds by squeezing the sponges or by soaking into an organic solvent (e.g. n-hexane), indicating the sponges being reusable. The RGO composite material holds great potentials to be used as an absorbent material for large-scale cleaning of oil spills in the sea or land.

The RGO composite materials can be used to clean the oils in the surrounding environments (e.g. the kitchen) or the oils stained on the hands (including the stationary oil, bicycle chain grease, marker pen inks, dyes and paints) more rapidly and effectively, thus having stain removal efficiency far superior than that of the commercial products.

It will be apparent to those skilled personal that various modifications and variations can be made to the structure of the present invention without departing from the scope or spirit or the invention. In view of the foregoing descriptions, it is intended that the present invention covers modifications and variations of this invention if they fall within the scope of the following claims and their equivalents.

What is claimed is:

1. A reduced graphene oxide composite material, comprising:
a substrate, wherein the substrate comprises a fibrous material or a porous material; and
a reduced graphene oxide sheet coated on and/or into the substrate, wherein the reduced graphene oxide sheet is functionalized with a polymer and coated with a silane compound or a porphyrin compound, and wherein the reduced graphene oxide composite material is prepared according to the following method:
soaking the substrate in an aqueous solution of the polymer/graphene oxide;
adding a crosslinking agent or a chelating agent and adjusting a pH of the solution to be weakly acidic;
adding a reducing agent to reduce graphene oxide absorbed onto the substrate into reduced graphene oxide through a hydrothermal approach, so as to obtain the polymer-reduced graphene oxide-the substrate; and
soaking the polymer/reduced graphene oxide/the substrate in a solution of the silane compound or the porphyrin compound at an ambient temperature to obtain the reduced graphene oxide composite material.

2. The reduced graphene oxide composite material according to claim 1, wherein the silane compound is phenyltrimethoxysilane or vinyltrimethoxysilane.

3. The reduced graphene oxide composite material according to claim 1, wherein the silane compound is phenyltrimethoxysilane and a content of phenyltrimethoxysilane in the reduced graphene oxide composite material is 5%-20%.

4. The reduced graphene oxide composite material according to claim 3, wherein the content of phenyltrimethoxysilane in the reduced graphene oxide composite material is 20%.

5. The reduced graphene oxide composite material according to claim 1, wherein the porphyrin compound is iron porphyrin.

6. The reduced graphene oxide composite material according to claim 1, wherein the crosslinking agent or the chelating agent is 1-ethyl-3-(3-dimethylaminopropyl)carbodiimide (EDC), ethylenediaminetetraacetic acid (EDTA) or citric acid .

7. The reduced graphene oxide composite material according to claim 1, wherein the polymer is polyethylenimine, polyvinyl alcohol or polyethylene oxide.

8. The reduced graphene oxide composite material according to claim 1, wherein the reducing agent is hydrazine, graphene oxide adsorbed onto the substrate is reduced into reduced graphene oxide through the hydrothermal approach under a temperature of 60° C.-120° C. for 1-24 hours.
